(19) United States
(12) Patent Application Publication
(10) Pub. No.: US 2004/0213889 A1
(43) Pub. Date: Oct. 28, 2004

(54) Method for active dry yeast rehydration and rehydration medium

(76) Inventors: Laurent Dulau, Toulouse (FR); Anne Ortiz-Julien, Toulouse (FR); Gianni Trioli, Piacenza (IT)

Correspondence Address: YOUNG & THOMPSON, 745 SOUTH 23RD STREET 2ND FLOOR, ARLINGTON, VA, 22202

(21) Appl. No.: 10/479,965

(22) PCT Filed: Jun. 7, 2002
(86) PCT No.: PCT/FR02/01949

(30) Foreign Application Priority Data
Jun. 8, 2001 (FR) 0107535

(51) Int. Cl. A23J 1/00

(52) U.S. Cl. 426/656

(57) ABSTRACT

Method for rehydration active dry yeasts intended for alcoholic fermentation includes placing the active dry yeasts in an aqueous medium containing at least inactive yeasts or a yeast derivative, and optionally one or several complementary nutrients selected among sources of organic or inorganic nitrogen, vitamins, mineral salts, fatty acids, sterols, or natural sources rich in those elements. The invention also concerns the rehydrating media used in the method. The invention which enables to avoid fermentation problems is useful for producing wines and other fermented alcoholic drinks.

The present invention concerns the technical sphere of the production of alcoholic drinks, in particular that of the production of wines. In this sphere, problems associated with fermentation represent an important loss of profit in economic terms. In fact these fermentation problems translate, in the case of the wines concerned, into output losses, loss of quality, indeed sometimes into volume losses. It is therefore important for businesses in this field to reduce the frequency of occurrence of fermentation problems.

In a manner which is now widespread, pure yeast cultures are used to permit a rapid start and regular progress of the fermentation of the grape musts. Pure cultures of vinification yeasts are stocks selected from the family of Saccharomyces belonging generally to the species cerevisiae, uvarum or bayanus.

However, one of the critical moments of fermentation remains the end of this fermentation. It is essential to be able to terminate this reaction with sufficient speed of consumption of sugars to avoid situations of stoppages or of flagging fermentations which represent risk situations, when other micro-organisms, notably lactic acid bacteria are able in these circumstances to colonise rapidly the fermentation medium stopping definitively the alcoholic fermentation. Certain of these micro-organisms will utilise the residual sugars to produce undesirable metabolites such as, for example, acetic acid, resulting in losses of quality in the case of the wine concerned.

By problematic fermentations are to be understood fermentations corresponding to two types of situation: slow fermentations and flagging fermentations. The fermentation speed of a medium is defined as the quantity of carbon dioxide released per time unit. It is represented by the curve derived from the quantity of carbon dioxide released as a function of time V=dCO₂/dt.

In the case of slow fermentations, the maximum observed speeds in the course of the fermentation are low. These slow fermentations are generally attributable to yeast populations which have low metabolic activity, in general associated with a deficiency of assimilable nitrogen in the musts.

Flagging fermentations or fermentation stoppages are characterised by a maximum fermentation speed which is relatively high but which diminishes progressively, the viability of the yeasts becoming very weak. These fermentations slow down significantly then or stop totally when the yeast population is insufficient to ensure the complete consumption of the sugars. In the majority of cases, this type of phenomenon is observed when there is oxygen deficiency or major nitrogen deficiency.

It is well known that these problematic fermentations are most frequently associated with imbalances or deficiencies of the nutritive media (Alexandre et al. J. of Ind. Microbiol. and Biotechnology, vol. 20, 1998: pages 20-27). Indeed, different nutrients are necessary to allow yeasts on the one hand to develop sufficiently well to colonise the fermentation medium and on the other hand to ensure effectively the metabolism of the sugars in alcohol, and this to the point of total exhaustion of these sugars. These nutrients belong especially to the following categories: sources of nitrogen, sources of oxygen, vitamins, mineral salts.

Assimilable nitrogen is constituted by ammonia nitrogen and α-amino-nitrogen. This is the nutrient which has the greatest influence on the speed of alcoholic fermentation (Agenbach. Proc. South African Soc. Enol. Vitic., Cape town, South Africa. Stellenbosh S A, 1977: pages 66-87). Nitrogen is an essential element since it allows the synthesis of protein, and thus the growth of the yeasts. Its deficiency in the must firstly limits the growth of yeast and thus the fermentation speed and secondly causes a significant diminution in the movement of sugars, thus increasing the risks of fermentation stoppage or of flagging fermentation. A nitrogen deficiency may also result in a deviation of the metabolism of the yeast, resulting especially in the production of hydrogen sulphide (H₂S), which is harmful to the aromatic characteristics of the wine.

In general, musts contain between 80 and 400 mg/l while the deficiency threshold is situated between 150 and 180 mg/l. A nitrogen deficiency in the must is thus a major risk for the good progress of wine production.

Oxygen plays a paramount role in alcoholic fermentation. It ensures the proper development of the yeast population and supports the viability of the yeast. It allows the synthesis of lipid compounds such as sterols or unsaturated fatty acids, constituting the cell membrane of the yeasts and fostering a better resistance to ethanol. The fluidity of the membrane is in effect a function of the ratio of unsaturated fatty acids/saturated fatty acids. The presence of unsaturated fatty acids is thus paramount for this resistance to alcohol.

The minimum requirements of O₂ to ensure the successful progress of a fermentation may be estimated at around 5-10 mg/l (Sablayrolles and Barre. Sci. Alim., vol. 6, 1986: pages 373-383). However, oxygen is very rapidly consumed at the start of fermentation firstly by the enzymes (case of decomposition: laccase), and secondly by the oxidising yeast flora. Wine growers are therefore driven to add oxygen in the course of fermentation, before the medium is exhausted. The timing of the addition of this element (mid-fermentation, after the multiplication of cells and the dilution of lipids in the fermentation flora) is thus paramount.

Another known means of avoiding fermentation problems linked to an oxygen deficiency is the addition to the must of unsaturated fatty acids, of sterols or of compounds rich in these molecules such as mud and certain yeast derivatives.

Certain vitamins play an essential role in the progress of alcoholic fermentation. Biotin for example encourages the production of esters and allows a better cellular viability at the end of the fermentation. In the event of biotin deficiency, cellular growth is significantly affected. Pantothenate, involved in the metabolism of lipids, has a positive effect on the organoleptic qualities: it reduces the risks of production of H₂S as well as of volatile acidity. Thiamine finally, the role of which has been the subject of numerous studies, is another of the vitamins which can be limiting and the lack of which can cause stoppage of fermentation. This deficit is often attributable to certain pre-fermentation treatments carried out in badly controlled conditions (sulphidising, heating). In fact, thiamine possesses the property of combining rapidly with SO₂ and is then no longer biologically available. It can also moreover disappear rapidly from the medium. It has been effectively shown (Bataillon et al., J. Ferm. Bioeng., vol. 82, 1996: pages 145-150) that in the presence of 10⁶ cells of Saccharomyces cerevisiae/ml, virtually all of the thiamine has disappeared in 2 to 3 hours, the yeasts being able to accumulate important concentrations of it. Moreover the non-yeast indigenous flora consumes this element sometimes more rapidly than the Saccharomyces cerevisiae.

Other nutrients such as magnesium, zinc, manganese or potassium are also very important for the activity of the yeast. Magnesium in particular plays an essential role in the control of cellular growth and the metabolism of the yeasts. It allows a better resistance to temperature and to osmotic pressure. It operates at the level of the maintenance of cellular integrity (stabilisation of nucleic acids, of polysaccharides, lipids and proteins) (Walker, Critic. Rev. Biotechnol., vol. 14, 1994: pages 311-354). Magnesium additions increase the production of ethanol. Zinc is also very important for it is a co-factor of the enzymes in glycolysis; it allows a better alcohol tolerance and plays an important role in the production of esters.

Even though deficiencies in these mineral elements are infrequent, they are only rarely biologically available. In fact, as these cations can be linked to different types of molecules in the must such as proteins and polyphenols, the yeast cannot use them.

The composition of the musts in nutrients which are useful for the yeasts is thus considered a crucial feature for the good management of wine production. The possibility of a deficiency in one or other nutrient means taking an important risk in respect of the product which will ultimately be obtained. It is for this reason that certain solutions have been proposed and are currently practised, in order to avoid these deficiency risks.

Nowadays, a plurality of techniques are implemented in order to supplement deficient musts during the entire fermentation process and to reduce the frequency of occurrence of problematic fermentations:

for deficiencies in nitrogen: the addition to the must of di-ammonia phosphate or of ammonium sulphate at mid-fermentation is advocated (Sablayrolles et al., J. Ferm. Bioeng., vol. 82, 1996: pages 377-381).

for oxygen deficiencies and deficiencies in growth factors, the addition to the must of fine mud allows the control of turbidity and supplies nutrients such as sterols and unsaturated fatty acids (Delfini et al., Am. J. Enol. Vitic., vol. 44, 1993: pages 86-92). However this addition is not always easy to implement in practice, in the cellars. It is for this reason that the addition of complex products containing inactive yeasts has been suggested in order to compensate for deficiencies in the must. These products generally contain, in addition to inactive yeasts or yeast hulls, ammonium phosphate and thiamine. Besides their nutritive properties, they influence the overall quality of the wines. The effectiveness of the addition of such products has been demonstrated in numerous oenological situations (Trioli. Vitic. Enol. Sci., vol. 51(3), 1996, pages 204-209).

Recently, a particularly effective means of intervention has been developed in order to reduce the risks of fermentation stoppage (Sablayrolles et al., J. Ferm. Bioeng. vol. 82, 1996: pages 377-381). It consists in supplying simultaneously a nitrogen and oxygen to the must. It is then noted that the effects are cumulative. It is however paramount that these combined additions are controlled; the timing of the supply and the quantity of nutrients supplied being essential.

Finally the addition of thiamine is a current practice. Usually it is added at the start of fermentation which renders it largely unavailable for the yeast responsible for ensuring alcoholic fermentation.

It should be noted moreover, that recent studies on the characterisation of the needs, in terms of assimilable nitrogen and oxygen, of different fermentation yeasts allow the operator to choose his yeast according to the nutritive quality of the must which he has to ferment (Julien et al., Am. J. Enol. Vitic., vol. 51 (3), 2000: pages 215-222).

However this knowledge does not permit freedom from correcting the musts for certain nutritive factors.

Thus all the technical solutions described and utilised up to present are based on the same principle; realising one or more additions to the must of nutrients indispensable to the fermentative activity of the yeast at the start of or in the course of fermentation.

These methods do not make it possible to supply the useful nutrients directly to the yeast in a quantity and/or a concentration sufficient to maintain a high fermentation speed right to the end of the fermentation, nor to escape the problem of the availability of certain elements essential to the good development of the fermentation yeast.

Consequently, despite the application of these techniques, there exist still a large number of situations of problematic fermentation.

In the last twenty years, the use of specially selected leavens in dried form (active dry yeasts, ADYs) has become widespread. Before they are used, it is necessary to operate a rehydration step. This step is relatively simple to put into operation but is fundamental for the quality of the leaven once rehydrated (Monk. Proceedings of the ASVO Seminar: Advances in Juice Clarification and Yeast Inoculation. Melbourne, Aus. 22-23, 1997).

Numerous authors have provided the theoretical bases and have described the structural and biochemical transformations which operate in yeast cells during dehydration and rehydration operations (M. J. Bakers et. al., Advances in Biochemical Engineering/Biotechnology, vol. 35, 1987, pp. 127-171). The optimal conditions to be implemented during rehydration in order to avoid as far as possible the destruction of the cells have also been the subject of various studies. One of the most complete was carried out by Radler et al. on the rehydration of vinification yeasts (Von F. Radler et al., Deutsche Lebensmittel-Rundschau, vol. 3, 1985, pp. 73-77). It has thus been revealed that the composition of the rehydration medium had an influence on the metabolic activity of the yeast measured during the first two hours after rehydration. In particular the mixtures of grape juice and of water, and solutions containing a specific quantity of glucose, fructose, malic acid, amino acids, 2-ketoglutaric acid, ammonium sulphate, vitamins or of KCl, of CaCl₂ and of NaCl have had a more or less marked effect on the metabolic activity of the dry yeast cells, the greatest increase in activity having been obtained with a 1% solution of KCl.

The objective of this study, like most of those carried out in this field, was to obtain a rate of revivified cells which was the highest possible thanks to defined rehydration conditions, the decisive criterion being the capacity of the yeast to resume high fermentation activity in the shortest time limits. The composition of the rehydration media was designed as a function of this criterion, tested over tests of short duration, the nature of the constituents of said media and the concentrations implemented aiming essentially at preserving the integrity of the cell membrane and stabilising the osmotic pressure, for example by the addition of salts.

However, it has not been demonstrated that specific rehydration conditions of the yeast could have a longer-term influence on the fermentation activity of the yeast cells. In particular, it has not been suggested up to present that a solution permitting the avoidance of problematic fermentation should be sought in the rehydration conditions of the yeasts, i.e. before they are introduced into the must to be fermented.

In a surprising and unexpected manner, it was found that rehydration of active dry yeasts (ADYs) in a medium with an added nutritive complex comprising yeast derivatives and possibly other nutrients permitted the fermentation capacity of the yeast produced from this rehydration step to be increased, especially at the end of fermentation, whereas it was not possible to observe such effects with the addition of this type of complex to the must.

The present invention thus proposes a method permitting the avoidance of problematic fermentation, notably thanks to the utilisation of specific rehydration media for active dry yeasts, as well as to the application of this method to the production by fermentation of wines and other alcoholic drinks.

The subject matter of the present invention is a method of rehydrating active dry yeasts for alcoholic fermentation wherein said active dry yeasts are placed in an aqueous medium containing at least inactive yeast or a yeast derivative. According to a variant of the method according to the invention, the rehydration medium for the ADYs may also contain one or more supplementary nutrients liable to be found in insufficient concentration or insufficient availability in the must. These supplementary nutritive elements are chosen from sources of organic or inorganic nitrogen, vitamins, mineral salts, fatty acids, sterols, or natural sources rich in these elements.

The active dry yeasts concerned are all vinification yeasts used to culture grape musts in order to insure good starting and regular progress of the fermentation. These are in particular yeasts of the Saccharomyces family, preferably Saccharomyces cerevisiae.

Inactive yeasts and yeast derivatives are well known to the person skilled in the art and are commercially available. It is understood that in the present method may be used inactive yeasts enriched with mineral salts, for example such as those described in the patent application GB 98 1110.0, or inactive yeasts enriched with any other nutrient. Yeast derivatives are all the products capable of being obtained from whole or partial yeast cells, by physical or chemical action. They include in particular, yeast extracts obtained by autolysis and yeast hulls. They present most often in the form of more or less fine powder after grinding and according to the invention, they are used in suspension in the rehydration medium.

The rehydration medium used is based on an aqueous medium which may or may not be sugary. In the case of a sugary medium, glucose water or grape juice is used by preference, as is the current practice, generally taken from the must which is intended to be fermented.

The inactive yeasts or yeast derivatives as well as the supplementary nutrients are introduced into the base medium, then the ADYs are added in such a way that the rehydration takes place from the start in the medium as defined. Thus the method according to the invention comprises essentially the steps consisting in:

a) preparing a rehydration medium comprising, in an aqueous medium which is or is not sugary,

i) at least inactive yeasts or a yeast derivative,

ii) and possibly in addition one or more nutrients chosen from sources of organic or inorganic nitrogen, vitamins, minerals salts, fatty acids, sterols, or natural sources rich in these elements,

b) introducing the active dry yeasts into the rehydration medium thus prepared;

c) incubating the rehydration medium containing the dry active yeasts.

According to a particular aspect of the invention, the method can be implemented in the following manner. Introduced into the aqueous base medium are:

(i) inactive yeasts or a yeast derivative, at the rate of 100 to 200 g/l, preferably 150 g per litre of medium,

ii) and possibly one or more supplementary nutrients chosen from ammonium salts, nitrates, urea, amino acids, peptides, proteins or a biological source rich in nitrogen; a fatty acid, a sterol, a combination of these or a natural source rich in these elements such as especially mud: thiamine, biotin, pantothenic acid, niacin, riboflavin, pyridoxine, or a natural source rich in vitamins; phosphates, salts of: zinc, magnesium, calcium, potassium, sodium, iron, copper, manganese or a combination of these mineral salts; each selected nutrient being added at a concentration which is 200 to 1000 times greater, preferably 500 times greater than that which it will have in the must to be fermented.

Then the active dry yeasts are introduced into the rehydration medium thus prepared at a rate of 50 to 150 g/l, preferably 100 g/l of medium and the rehydration medium containing the active dry yeasts is incubated at a temperature of between 30° C. and 45° C., preferably 37° C., for 20 to 40 minutes, preferably 30 minutes.

In other words, the ADYs are rehydrated in a medium which has a much greater concentration of nutrients than the must in which they are intended to develop their fermentation activity will have. During culturing, the inoculum containing the revivified ADY cells and the rehydration medium supplies all of its constituents to the must. The dilution factor will be a function of the respective volumes rehydration medium/fermentation medium. In an unexpected manner, this ratio is advantageously fixed so that the concentrations of supplementary nutrients in the must are of the same order of magnitude as the concentrations usually introduced into musts at the start of or in the course of fermentation. For example, if C1 is the desired concentration of the nutrient N1 in the must and the culture volume is 20 ml for one litre of must, or a factor of 500, then the rehydration medium should contain N1 in a concentration of the order of 500×C1.

According to a preferred embodiment of the invention, the method can be implemented in the following manner. Into the aqueous base medium are introduced

i) inactive yeasts or a yeast derivative, at a rate of 100 to 200 g/l, preferably 150 g/litre of medium,

ii) and in addition one or more of the following constituents: 20 to 50 mg/l of calcium pantothenate, 0.15 to 0.30 mg/l of biotin, 20 to 60 mg/l of zinc salt, 200 to 500 mg/l of magnesium salt, 2 to 5 mg/l of manganese salt.

Then the active dry yeasts are introduced into the rehydration medium thus prepared at a rate of 50 to 150 g/l, preferably 100 g per litre of medium; and finally the rehydration medium containing the active dry yeasts is rehydrated at a temperature of between 300 and 45°, preferably 37° C., for 20 to 40 minutes, preferably 30 minutes.

Another object of the present invention is a rehydration medium for active dry yeasts which is capable of being used in the method described previously. Such a medium comprises at least, in a medium with an aqueous base:

i) inactive yeasts or yeast extracts,

ii) and in addition possibly one or more nutrients chosen from sources of organic or inorganic nitrogen, vitamins, mineral salts, fatty acids, sterols, or natural sources rich in these elements.

In an advantageous manner, into said rehydration medium are introduced, in an aqueous medium which is or is not sugary,

i) inactive yeasts or a yeast derivative, at the rate of 100 to 200 g/l, preferably 150 g per litre of medium, and

ii) one or more nutrients chosen from ammonium salts, nitrates, urea, amino acids, peptides, proteins or a biological source rich in nitrogen; a fatty acid, a sterol, a combination of these or a natural source rich in these elements such as especially mud: thiamine, biotin, pantothenic acid, niacin, riboflavin, pyridoxine, or a natural source rich in vitamins; phosphates, salts of: zinc, magnesium, calcium, potassium, sodium, iron, copper, manganese or a combination of these mineral salts, at a concentration which is 200 to 1000 times greater, preferably 500 times greater, than that which it will have in the must to be fermented.

In particular, the rehydration medium for active dry yeasts according to the invention can comprise at least

i) inactive yeasts or yeast extracts, at the rate of 100 to 200 g/l, preferably 150 g/l,

ii) one or more of the following constituents: 27 mg/l of calcium pantothenate, 0.2 mg/l of biotin, 50 mg/l of zinc sulphate, 433 mg/l of magnesium sulphate, 4 mg/l of manganese sulphate,

in an aqueous medium, preferably water with glucose added at a rate of 50 g/l, or grape juice.

An object of the present invention is also a dry composition intended for the preparation of a rehydration medium for active dry yeasts, comprising at least

i) inactive yeasts or a yeast derivative, in dehydrated form,

ii) one or more supplementary nutrients, chosen from sources of organic or inorganic nitrogen, vitamins, mineral salts, fatty acids, sterols or natural sources rich in these elements.

Said dry composition can in particular contain especially

i) at least 98 by weight of inactive yeasts or a yeast extract, in dehydrated form,

ii) one or more nutrients chosen from ammonium salts, nitrates, urea, amino acids, peptides, proteins or a biological source rich in nitrogen; a fatty acid, a sterol, a combination of these or a natural source rich in these elements such as especially mud: thiamine, biotin, pantothenic acid, niacin, riboflavin, pyridoxine, or a natural source rich in vitamins; phosphates, salts of: zinc, magnesium, calcium, potassium, sodium, iron, copper, manganese or a combination of these mineral salts.

In an advantageous manner it can be made up of

i) about 99.3% by weight of inactive yeasts or yeast derivative, in dehydrated form,

ii) one or more nutrients chosen from pantothenic acid, biotin, a zinc salt, a magnesium salt, a manganese salt.

The inoculum, prepared by the method of rehydrating ADYs according to the invention or with the aid of the claimed rehydration medium, can be used to culture a must intended for the production of a fermented alcoholic drink. It will be introduced into the must in a quantity defined in advance as a function of the concentrations of ADY, inactive yeast or yeast derivatives and supplementary nutrients introduced into the rehydration medium according to the dilution criteria defined previously, i.e. from 200 to 1000 times, preferably 500 times.

The present invention will find natural application in the production of a fermented alcoholic drink from a grape juice, such as a wine. A fermented alcoholic drink thus obtained is also claimed.

The following examples illustrate in a non-restrictive manner embodiments of the present invention.

### EXAMPLES

### Example 1

### Improvement of the Fermentation Profile of a Synthetic must by the Incorporation of a Yeast Extract in the Rehydration Medium of the Fermentation Yeast.

Three fermentations were carried out in parallel and in duplicate on a synthetic must MS70-fa (such as described in Bely et al. (1990)) corresponding to a medium deficient in assimilable nitrogen (100 mg/l) and containing 200 g/l of fermentable sugars. The active dry yeast used is the commercial yeast Lalvin EC1118™.

Rehydration Media

Mo: control rehydration medium: water with glucose added at a rate of 50 g/l.

Me: rehydration medium containing a yeast extract (Bacto-yeast extract ref. 0127-01-7, DIFCO, USA), used in a dosage such as to permit a final concentration of extract in the fermentation must of 30 g/hl, or 150 g per litre of rehydration medium.

Rehydration

1—One gram of the active dry yeast EC1118™ is rehydrated in 10 ml of medium Mo at 37° C. for 30 minutes.

2—One gram of the active dry yeast Lalvin EC1118™ is rehydrated in 10 ml of medium Me at 37° C. for 30 minutes.

Fermentations

Fo: control fermentation carried out with the yeast rehydrated in medium Mo. No yeast extract is present.

F1: fermentation carried out with the yeast rehydrated in medium Mo. A yeast extract is added at the start of the alcoholic fermentation directly into the synthetic must at a rate of 30 g/hl.

F2: fermentation carried out with the yeast rehydrated in medium Me containing the yeast extract which is to be found at a level of 30 g/hl in the synthetic must.

Three fermentors containing 1.1 litres of synthetic must MS70-fa are inoculated with 2.2 ml of rehydration solution (which corresponds to a utilisation dosage of 20 g/hl of active dry yeast). The fermentation temperature is 24° C. The production of CO₂ is increased as a function of time.

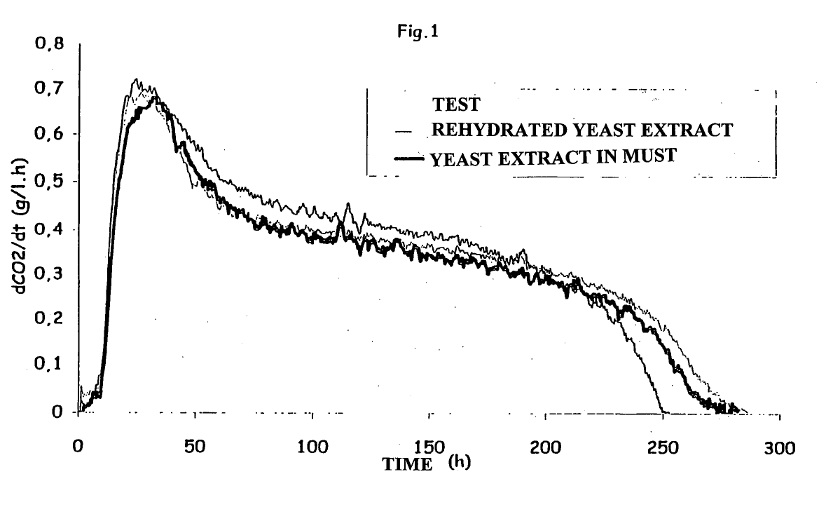

The results obtained (FIG. 1) show that the fermentation carried out by the rehydrated yeast in the presence of yeast extract in the rehydration medium (form 2) terminates before the two other fermentations (forms Fo and F1). The kinetics of the end of fermentation characterised by the slope of the curve are more rapid in form F2 explaining the observed time saving of approximately 50 hours in comparison with the other forms. The addition of yeast extract, at the start of alcoholic fermentation, does not, in these conditions, permit an improvement in the fermentation profile in comparison with the control form Fo.

### Example 2

### Improvement of the Fermentation Profile of a Real Chardonnay must by the Incorporation of a Yeast Extract into the Rehydration Medium of the Fermentation_Yeast

Two fermentations are carried out in parallel and in duplicate on a real Chardonnay must coming from the south of France (Languedoc region) and containing 365 mg/l of assimilable nitrogen (situation of no deficiency) and containing 220 g/l of fermentable sugars. The active dry yeast used is the commercial yeast Lalvin EC1118™, inoculated in a dosage of 20 g/hl.

Rehydration

One gram of the dry yeast Lalvin EC1118™ is rehydrated in 10 ml of glucose water (50 g/l) at 37° C. for 30 minutes. In the control rehydration, no addition is made. In form 2, 1.5 g of yeast extract (Bacto-yeast extract ref. 0127-01-7, DIFCO, USA) is added to 10 ml of the rehydration medium.

Fermentation

The two fermentations correspond to the following forms:

F1: Fermentation carried out with the yeast EC1118™ rehydrated in a rehydration medium in the absence of yeast extract. The yeast extract is added at the start of alcoholic fermentation directly into the Chardonnay must in a dosage of 30 g/hl.

F2: Fermentation carried out with the yeast EC1118™ rehydrated in the presence of a yeast extract (used in a dosage permitting a concentration of 30 g/hl in the must) in the rehydration medium.

The fermentors of 1.1 litres are inoculated with 2.2 ml of rehydration solution containing the ADYs, corresponding to a utilisation dosage in the must of 20 g/hl of active dry yeasts. The fermentation temperature is 24° C. The production of CO₂ increases as a function of time.

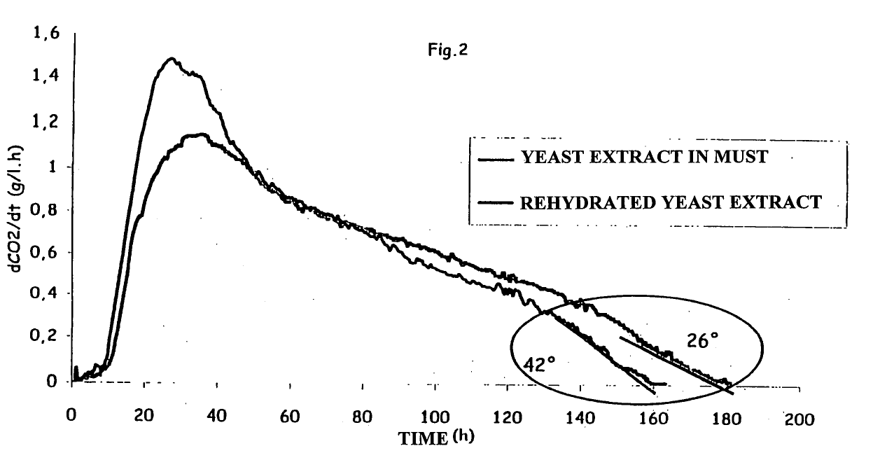

The results obtained (FIG. 2) show that the fermentation carried out by the rehydrated yeast in the presence of yeast extract in the rehydration medium (form F2) is completed before the control fermentation F1. The kinetics of the end of fermentation characterised by the slope of the curve are more rapid in form F2 explaining the time saving observed in comparison with the control form. Even in the absence of a deficiency of assimilable nitrogen, the addition of yeast extract, during rehydration, permits an improvement in the end of alcoholic fermentation by influencing the fermentation kinetics (42° slope of the curve of end of fermentation by comparison with 26° in the control fermentation). The result of example 1 observed in the synthetic must is thus confirmed with the real must, namely that the addition of yeast extract into the rehydration medium allows a faster fermentation than with the same addition in the must at the start of alcoholic fermentation.

### Example 3

### Influence of the Addition of Different Nutrients on the Duration of Fermentation of a Deficient Synthetic must

12 fermentations were carried out in parallel and in duplicate on a synthetic must MS70-fa such as described in example 1, and corresponding to a medium deficient in assimilable nitrogen (100 mg/l) and containing 200 g/l of fermentable sugars. The active dry yeast used is the commercial yeast Uvaferm CEG™ inoculated at a dosage of 20 g/hl. The yeast extract is the commercial extract Bacto-yeast extract ref. 0127-01-7 (DIFCO, USA). The vitamins and mineral salts are the standard products available from suppliers.

The 12 fermentations correspond to the following forms:

F1 and 2: Controls in which no yeast extract is added either into the rehydration medium of the yeast or into the fermentation medium. The control rehydration medium is the base medium: water with glucose added at 50 g/l.

F3: Fermentation carried out with the yeast CEG™ rehydrated in the presence of yeast extract (used at a dosage permitting a concentration of 30 g/hl in the must) in the rehydration medium.

F4: Fermentation carried out with the yeast CEG™ rehydrated in a control rehydration medium. The same yeast extract as for F3 is added at the start of alcoholic fermentation directly into the synthetic must MS70-fa in a dosage of 30 g/hl.

F5: Fermentation carried out with the yeast CEG™ rehydrated in the presence of inactive yeast (LBI2130™, Lallemand, Canada, utilised in a dosage permitting a concentration in the must of 30 g/hl) in the rehydration medium.

F6: Fermentation carried out with the yeast CEG™ rehydrated in a control rehydration medium. The same inactive yeast as for F5 is added at the start of alcoholic fermentation directly into the synthetic must MS70-fa in a dosage of 30 g/hl.

F7: Fermentation carried out with the yeast CEG™ rehydrated in the presence of di-ammonia phosphate (used in a dosage permitting a concentration of 10 g/hl in the must) in the rehydration medium.

F8: Fermentation carried out with the yeast CEG™ rehydrated in the control rehydration medium. Di-ammonia phosphate is added at the start of alcoholic fermentation in a dosage of 10 g/hl.

F9: Fermentation carried out with the yeast CEG™ rehydrated in the presence of a cocktail of vitamins (pantothenate, thiamine and biotin) in the rehydration medium in such a fashion as to obtain respective concentrations in the must of 60 μg/l, 34 μg/l, and 0.5 μg/l.

F10: Fermentation carried out with the yeast CEG™ rehydrated in the control rehydration medium. The cocktail of vitamins used for F9 is added at the start of alcoholic fermentation at the concentrations indicated above.

F11: Fermentation carried out with the yeast CEG™ rehydrated in the presence of a cocktail of mineral salts (Mg²⁺, Zn²⁺, Mn²⁺ in the form of sulphates) in the rehydration medium in such a way as to obtain respective concentrations of the salts in the must of 460 μg/l, 58 μg/l and 4.5 μg/l.

F12: Fermentation carried out with the yeast CEG™ rehydrated in the rehydration medium. The cocktail of mineral salts used for F11 is added at the start of alcoholic fermentation at the concentrations indicated above.

The rehydration conditions are identical whatever the type of added product (yeast extract, inactive yeast, diammonia phosphate, cocktail of vitamins or of mineral salts). They correspond to those applied in examples 1 and 2. The volumes and conditions of fermentation are identical to those described in examples 1 and 2. The results obtained are recorded in table 1 below. The values presented correspond to the average duration of fermentation in hours with duplicates for each form.

TABLE 1

fermentation time, in hours

| | in rehydration | at start of |
|---|---|---|
| Added product | medium | fermentation |
| 0 | 290 | 290 |
| Yeast extract | 250 | 280 |
| Inactive yeast | 275 | 282 |
| Di-ammonia phosphate | 280 | 285 |
| Cocktail of vitamins | 283 | 288 |
| Cocktail of salts | 265 | 270 |

The results show that no matter what type of nutritive element is added, the additions during the rehydration phase result in a better reduction in the duration of fermentation than the same additions made at the start of alcoholic fermentation.

### Example 4

### Dry Composition and Corresponding Rehydration Medium M1

Dry powder composition ready for use:

| | | |
|---|---|---|
| inactive yeast | 998.10 | g |
| di-ammonia phosphate | 333.33 | g |
| pantothenic acid | 200.00 | mg |
| thiamine | 113.33 | mg |
| biotin | 1.65 | mg |
| zinc sulphate | 195.00 | mg |
| magnesium sulphate | 1500.00 | mg |
| manganese sulphate | 15.00 | mg |

A quantity of 150 g of this dry composition is weighed and introduced into 1 litre of water with 50 g/l glucose added. The following rehydration medium M1 is obtained.

| | | |
|---|---|---|
| inactive yeast | 149.71 | g/l |
| di-ammonia phosphate | 50.00 | g/l |
| pantothenic acid | 30.00 | mg/l |
| thiamine | 17.00 | mg/l |
| biotin | 0.25 | mg/l |
| zinc sulphate | 29.25 | mg/l |
| magnesium sulphate | 225.00 | mg/l |
| manganese sulphate | 2.25 | mg/l |

### Example 5

### Method of Rehydrating a Commercial Vinification Yeast

15 g of dry active yeast Lalvin EC1118™ are introduced into 100 ml of rehydration medium M1 prepared according to example 4. After incubation for 30 minutes at 37° C., an inoculum is obtained which is ready to culture a must at the rate of 20 ml of inoculum per litre. The concentrations of nutrients supplied to the must are thus the following (it is assumed that the inoculated volume contains the said elements either in free form in the aqueous phase of the rehydration medium, or in the form assimilated by the rehydrated yeasts):

| | | |
|---|---|---|
| di-ammonia phosphate | 0.10 | g/l |
| pantothenic acid | 60.00 | μg/l |
| thiamine | 34.00 | μg/l |
| biotin | 0.50 | μg/l |
| zinc salt | 0.058 | μg/l |
| magnesium salt | 0.45 | μg/l |
| manganese salt | 4.50 | μg/l |

### Example 6

### Rehydration Medium M2 and Composition C2

In one litre of purified water are mixed 50 g of glucose and 150 g of the dry composition C2,

| | | | |
|---|---|---|---|
| comprising: | inactive yeasts | 149.49 | g |
| | calcium pantothenate | 27.0 | mg |
| | biotin | 0.2 | mg |
| | zinc salt | 50.0 | mg |
| | magnesium salt | 433.0 | mg |
| | manganese salt | 4.0 | mg |

In this medium M2, 100 g of active dry yeast Uvaferm CEG™, marketed by Lallemand, will be rehydrated. The medium M2 containing the rehydrated yeast will be inoculated into a must to be fermented at a rate of 0.08 to 0.4 l/hl, preferably 0.2 l/hl.

### Example 7

### Application to the Preparation of a Fermented Drink

The medium M2 containing the composition C2 has been used to rehydrate the ADYs and culture a fermentation must of a white wine in industrial conditions in a cellar in the region of la Mancha in Spain.

Type of Vine: Airen

Assimilable Nitrogen in the must: 225 mg/l (non-Deficient must)

Fermentations have been carried out in 100 hectolitre vats according to different forms, in order to determine the most favourable conditions. Two types of ADY have been used, on their own or in the presence of other substances jointly added to the musts to encourage fermentation. In particular the influence of diammonium phosphate and a fermentation activator, added to the fermentation medium, has been studied.

The active dry yeasts Uvaferm™ CEG (Lallemand, Canada) and Uvaferm™ PM (Lallemand, Canada) have been rehydrated with the aid of the medium M2 described in example 6. For each of the two yeasts, 4 tests have been carried out, by adding:

| | | |
|---|---|---|
| Test no. 1 | Di-ammonia phosphate | 0.2 g/l start of fermentation |
| Test no. 2 | Di-ammonia phosphate | 0.2 g/l start of fermentation |
| | Fermentation activator | 0.3 g/l first ⅓ fermentation |
| Test no. 3 | Composition C2 | 0.3 g/l (equiv) rehydration medium |
| | Di-ammonia phosphate | 0.2 g/l start of fermentation |
| Test no. 4 | Composition C2 | 0.3 g/l (equiv) rehydration medium |
| | Fermentation activator | 0.3 g/l first ⅓ fermentation |

The fermentation activator used is the activator Fermaid™ (Lallemand, Canada).

The kinetic profile of these eight fermentations was followed by measuring the density of the must and at the level of the production of a secondary component of fermentation, i.e. acetate. Indeed, acetate is responsible for the volatile acidity of wines which should be minimised in order to obtain good gustative qualities. The results obtained are recorded in tables 2 and 3 below.

The values presented in table 2 correspond to fermentation times in days for each form.

TABLE 2

fermentation time, in days

| Test no. | Uvaferm ™ CEG | Uvaferm ™ PM |
|---|---|---|
| 1 | 10 | 8 |
| 2 | 9 | 7 |
| 3 | 9 | 7 |
| 4 | 9 | 6 |

It appears that for the two active dry yeasts tested, the addition of the composition C2 into the rehydration medium makes it possible to substantially improve the profile of the fermentation kinetics (Test no. 3 compared to Test no. 1). Moreover, as can be seen with Test no. 4 in which the most rapid kinetics are obtained, the effect obtained by the addition of the composition C2 into the rehydration medium for the ADYs acts in a cumulative manner with the effect produced by the addition of a fermentation activator.

The values presented in table 3 correspond to the volatile acidity measured at the end of fermentation by the Duclaux-Gayon method, known to the person skilled in the art.

TABLE 3

Volatile acidity, in g/l

| Test no. | Uvaferm ™ CEG | Uvaferm ™ PM |
|---|---|---|
| 1 | 0.48 | 0.33 |
| 2 | 0.51 | 0.33 |
| 3 | 0.44 | 0.18 |
| 4 | 0.46 | 0.22 |

In view of these results, it appears that the addition of the composition C2 during rehydration makes it possible to reduce the production of volatile acidity. This could be attributable to the fact that the yeasts are in better physiological condition and thus capable of better withstanding the physico-chemical conditions encountered in a must which is fermenting. This physiological state would then translate into a better resistance to stress, causing a smaller production of volatile acidity.

This supplementary positive effect reinforces the interest of the method according to the present invention for the rehydration of ADYs intended for alcoholic fermentation. Generally speaking, the results obtained at the end of these tests confirm this interest on an industrial scale.

1-15. (cancelled)

16. Method of rehydrating active dry yeasts for alcoholic fermentation, characterised in that said active dry yeasts are placed in an aqueous medium containing inactive yeasts or a yeast derivative at a rate of 100 to 200 g/l, preferably 150 g per litre of medium.

17. Method of rehydrating active dry yeasts according to claim 16, characterised in that said active dry yeasts are placed in an aqueous medium containing in addition one or more nutrients chosen from sources of organic or inorganic nitrogen, vitamins, mineral salts, fatty acids, sterols or natural sources rich in these elements.

18. Method of rehydrating dry active yeasts according to claim 17, comprising essentially the steps consisting in:
a) preparing a rehydration medium comprising
i) inactive yeasts or a yeast derivative, at a rate of 100 to 200 g/l, preferably 150 g per litre of medium, and
ii) one or more nutrients chosen from ammonium salts, nitrates, urea, amino acids, peptides, proteins or a biological source rich in nitrogen; a fatty acid, a sterol, a combination of these or a natural source rich in these elements such as especially mud: thiamine, biotin, pantothenic acid, niacin, riboflavin, pyridoxine, or a natural source rich in vitamins; phosphates, salts of: zinc, magnesium, calcium, potassium, sodium, iron, copper, manganese or a combination of these mineral salts, each selected nutrient being added at a concentration which is 200 to 1000 times greater, preferably 500 times greater than that which it will have in the must to be fermented, in an aqueous medium, preferably glucose water or grape juice,
b) introducing the active dry yeasts into the rehydration medium thus prepared at a rate of 50 to 150 g/l, preferably 100 g per litre of medium;
c) incubating the rehydration medium containing the active dry yeasts at a temperature of between 30° C. and 45° C., preferably 37° C., for 20 to 40 minutes, preferably 30 minutes.

19. Method of rehydrating active dry yeasts according to claim 18 comprising essentially the steps consisting in:
a) preparing a rehydration medium comprising,
i) inactive yeasts or a yeast derivative at a rate of 100 to 200 g/l, preferably 150 g per litre of medium, and
ii) one or more of the following constituents: 20 to 50 mg/l of calcium pantothenate, 0.15 to 0.30 mg/l of biotin, 20 to 60 mg/l of zinc salt, 200 to 500 mg/l of magnesium salt, 2 to 5 mg/l of manganese salt, in an aqueous medium, preferably glucose water or grape juice;
b) introducing the active dry yeasts into the rehydration medium thus prepared at a rate of 50 to 150 g/l, preferably 100 g per litre of medium;
c) incubating the rehydration medium containing the active dry yeasts at a temperature of between 30° C. and 45° C., preferably 37° C., for 20 to 40 minutes, preferably 30 minutes.

20. Rehydration medium for active dry yeasts, comprising at least, in an aqueous medium which is or is not sugary, inactive yeasts or a yeast derivative at a rate of 100 to 200 g/l, preferably 150 g per litre of medium.

21. Rehydration medium according to claim 20, comprising at least, in an aqueous medium which is or is not sugary,
i) inactive yeasts or a yeast derivative, at the rate of 100 to 200 g/l, preferably 150 g per litre of medium,
ii) one or more nutrients chosen from ammonium salts, nitrates, urea, amino acids, peptides, proteins or a biological source rich in nitrogen; a fatty acid, a sterol, a combination of these or a natural source rich in these elements such as especially mud: thiamine, biotin, pantothenic acid, niacin, riboflavin, pyridoxine, or a natural source rich in vitamins; phosphates, salts of: zinc, magnesium, calcium, potassium, sodium, iron, copper, manganese or a combination of these mineral salts, at a concentration which is 200 to 1000 times greater, preferably 500 times greater than that which it will have in the must to be fermented.

22. Rehydration medium for active dry yeasts according to claim 21, comprising at least, in an aqueous medium, preferably water with glucose added at a rate of 50 g/l, or grape juice,
i) inactive yeasts or yeast extracts, at the rate of 100 to 200 g/l, preferably 150 g/l,
ii) one or more of the following constituents: 27 mg/l of calcium pantothenate, 0.2 mg/l of biotin, 50 mg/l of zinc salt, 433 mg/l of magnesium salt, 4 mg/l of manganese salt.

23. Dry composition intended for the preparation of a rehydration medium for active dry yeasts according to claim 20, characterised in that it comprises at least
i) at least 98% by weight of inactive yeasts or of yeast derivative, in dehydrated form,
ii) one or more nutrients chosen from ammonium salts, nitrates, urea, amino acids, peptides, proteins or a biological source rich in nitrogen; a fatty acid, a sterol, a combination of these or a natural source rich in these elements such as especially mud: thiamine, biotin, pantothenic acid, niacin, riboflavin, pyridoxine, or a natural source rich in vitamins; phosphates, salts of: zinc, magnesium, calcium, potassium, sodium, iron, copper, manganese or a combination of these mineral salts.

24. Dry composition intended for the preparation of a rehydration medium for active dry yeasts according to claim 21, characterized in that it comprises at least
i) at least 98% by weight of inactive yeasts or of yeast derivative, in dehydrated form,
ii) one or more nutrients chosen from ammonium salts, nitrates, urea, amino acids, peptides, proteins or a biological source rich in nitrogen; a fatty acid, a sterol, a combination of these or a natural source rich in these elements such as especially mud: thiamine, biotin, pantothenic acid, niacin, riboflavin, pyridoxine, or a natural source rich in vitamins; phosphates, salts of: zinc, magnesium, calcium, potassium, sodium, iron, copper, manganese or a combination of these mineral salts.

25. Dry composition intended for the preparation of a rehydration medium for active dry yeasts according to claim 22, characterized in that it comprises at least
i) at least 98% by weight of inactive yeasts or of yeast derivative, in dehydrated form,
ii) one or more nutrients chosen from ammonium salts, nitrates, urea, amino acids, peptides, proteins or a biological source rich in nitrogen; a fatty acid, a sterol, a combination of these or a natural source rich in these elements such as especially mud: thiamine, biotin, pantothenic acid, niacin, riboflavin, pyridoxine, or a natural source rich in vitamins; phosphates, salts of:
zinc, magnesium, calcium, potassium, sodium, iron, copper, manganese or a combination of these mineral salts.

26. Dry composition according to claim 23, characterised in that it comprises at least
i) about 99.3% by weight of inactive yeasts or yeast extract, in dehydrated form,
ii) one or more nutrients chosen from pantothenic acid, biotin, a zinc salt, a magnesium salt, a manganese salt.

27. Method of producing a fermented alcoholic drink, characterised in that the must is cultured by yeasts prepared by a method according to claim 16.

28. Method of producing a fermented alcoholic drink, characterized in that the must is cultured by yeasts rehydrated in a medium according to claim 20.

29. Method of producing a fermented alcoholic drink, characterized in that the must is cultured by yeasts rehydrated in a medium according to claim 21.

30. Method of producing a fermented alcoholic drink, characterised in that the must is cultured by yeasts rehydrated in a medium according to claim 22.

31. Method of producing a fermented alcoholic drink according to claim 27, characterised in that the must is a grape juice.

32. Fermented alcoholic drink obtained by a method according to claim 27.
